(19) United States
(12) Patent Application Publication
(10) Pub. No.: US 2021/0229141 A1
(43) Pub. Date: Jul. 29, 2021

(54) CLOSET CLOTHES DUST PROTECTOR

(71) Applicant: James Philip Roake, Vancouver, WA (US)

(72) Inventor: James Philip Roake, Vancouver, WA (US)

(21) Appl. No.: 16/775,453

(22) Filed: Jan. 29, 2020

(51) Int. Cl. B08B 17/04; A47G 25/00

(52) U.S. Cl. CPC B08B 17/04; A47G 25/00

(57) ABSTRACT

A closet garment dust protection embodiment that does not rely on the hanger rod but uses other closet surfaces for support and installation primarily the shelf typically located above the hanger rod in a clothes closet. The dust protection system uses an elongated, rectangular panel of typically clear 12 to 20 mil vinyl that is custom cut to width of closet rod/shelf. Preferably 16 to 20 inches in height, the vinyl panel's two ends and one elongated edge are left raw while the remaining long edge is hemmed preferably using one part of a two part hook and loop system which is folded over the vinyl panel edge then stitched or welded into place. Typically the remaining part of the two part hook and loop system, measured to length of cut vinyl is then adhered to designated anchoring point. The hook and loop surfaces are pressed together for attachment. The affixed vinyl panel is then placed over the horizontal surfaces of hangered garments that protrude outward from the hanger rod protecting that portion of hangered garments from dust accumulation. Typically the closet shelf protects that portion of the garments hanging inward from hanger rod from dust accumulation.

### BACKGROUND OF THE INVENTION

Dust is the enemy and everyone hates the enemy but it is most hated in a clothes closet.

Clothes are hung on hangers which are then hung on the closet rod and unless precautions are taken, dust settles on them, particularly the horizontal surfaces of the clothes. Dust on the shoulders and on the collars of shirts and blouses are hated by all. Slacks draped over a hanger get dust lines at the fold. Even a filtering system fails to solve the problem. So unless one is willing to encapulate all their clothes in zippered bags or other inconvenient solutions they live with the dusty sleeves, shoulders, collars and the despised dust lines. Dust protectors presently available present their own set of problems. Limited capacity results in a need for many bags which themselves take up more room and give a closet a cluttered look. Often with zippers that are inconvenient or tailored for an individual garment that requires negotiating a hanger through a hole. The various products on the market protect closet clothes from dust accumulation but while protecting clothes they can be cumbersome, awkward, inconvenient, take up needed space, displeasing to the eye and give the closet a busy, disoriented appearance. All such products require either hangers hanging on hanger pole to support the embodiment or use the hanger pole itself for attachment. All the dust protectors presently available fully encapulate either the entire garment(s) or fully cover the top shoulder to shoulder portion of garments. Such encapulations not only require more space but also presents inconvenience when trying to remove or replace such an enclosed garment. The present invention, unlike all others, only covers the horizontal surfaces of garment and only that horizontal portion that protrude outward from the hanger rod while relying on the hanger rod shelf to protect the horizontal surfaces of garments that hang to the rear of the hanger rod and towards back of the closet. Using the shelf for such protection, means no additional protection barriers to encumber hanger reprieval or removal, thus allowing for easy retrieval and replacement of garments requiring only one hand to reach under the vinyl panel which extends only slightly vertically down a garment. This present invention does not use hanger hooks nor hanger rods for support but rather the overhead shelf which by doing so creates clearance of the rod pole and the accompanying ease to move about garments. The present invention is adaptive to any closet with no limitations as to width across the closet. The present invention gives a virtually limitless and continuous shield across a closet width of any size and it can be expanded or shortened to meet the needs of any closet as opposed to other embodiments that require multiple units.

### SUMMARY OF THE INVENTION

In its basic concept, the present invention is an embodiment of a single plane, elongated, rectangular and continuous panel of preferably 12 to 20 mil clear vinyl that has been cut to width of the closet hanger rod, then preferably affixed to a closet surface that preferably being the closet rod shelf surface that is typically installed above the hanger rod in a closet or in absence of such a shelf may be affixed to the ceiling above or the wall to the back of a closet or other available surfaces excluding the closet rod itself. The present invention can be cut, lengthened and modified to fit the typical clothes closet width. Once installed in place, the vinyl panel is of such a height, typically 14 to 20 inches that it extends outward from the attachment surface, preferably hanger rod shelf, toward front of closet and drops down over the clothes at the outer edge of the hanger thus covering the horizontal portion of clothes on hangers. Typically the present invention when installed on the top front of the closet shelf avoids contact with hanger rod or hanger hooks given that its anchored point creates an angle that allows the vinyl panel circumvention of the hanger rod. This avoidance allows for the simple and easy removal and replacement of hangers and hangered clothes stored beneath the embodiment. The present invention once it reaches the furthest most outward point of the hangered clothes simply drops vertically downward for several inches to give some vertical coverage of the hangered clothes. Affixing the vinyl to the desired anchoring point can be done in several ways ie. either by a removable method or a semi-permanent method. The removable method requires the use of a hook and loop product. In this method a binding or webbing is affixed by weld or stitch the entire length of one of the two long sides of the embodiment giving the vinyl panel added strength and backing and then one part of the two part hook and loop system is sewn or welded onto the entire length of the vinyl panel. The other half of the hook and loop system (matching in length that of the vinyl panel) with its adhesive side is then pressed onto the anchoring surface which typically is the top front side of the overhead shelf. The hook and the loop are then pressed together and the vinyl panel is now anchored and ready to protect. Other anchoring alternatives may include but not limited to are the front edge and bottom surface of the hanger rod shelf, and or the closet back wall or the closet ceiling or other available surfaces excluding hanger rod. Another option to this removable version of the embodiment is by hemming the vinyl panel on one long side creating typically a ¾ to 1 inch hem. This hem if created by simply folding over the vinyl and “welding” it together. The result is a strong backing which allows for the hook and loop to be sewn directly onto the vinyl without use of a reinforcing webbing. In the permanent method of installing this invention the binding or webbing is sewn onto one of the long edges of the vinyl or alternatively the vinyl is folded over and welded to create a small hem and no hook and loop is attached. Two sided tape is applied to predetermined anchoring surfaces ie. wall, ceiling of shelf surface and then treated edge of vinyl is adhered to the tape.

The present invention would typically be of a height (14 to 20 inches) that when affixed it would reach beyond the outer edge of a typical hanger hanging on the closet rod and then have a vertical drop down the outer edge of hanging garment several inches to insure full horizontal coverage of the garment while protecting the start of the vertical surfaces. Special applications may call for greater heights of the invention. The side edges and the bottom edge of invention are left raw with no hemming or bindings so as to insure a clean, unobstructed visual continuance from vinyl panel to garment. This raw edge treatment would also allow for a continuous visual appearance when additional panels are added. Horizontal surfaces not directly covered by the present invention are back beneath the shelf and the shelf serves as a protective cover from the dust. If present invention is installed on the closet ceiling or the closet back wall then all horizontal clothing surfaces including those back of hanger rod are protected from the dust.

The present invention is easy to install and can be tailored to fit varying widths of closets. All that is required is measuring tape, a square if cutting required, utility knife or pair of scissors and a marking device. When using the semi-permanent method of installation (two sided tape as opposed to use of hook and loop), measure the width of the shelf (if no shelf then width of closet) then cut two sided tape to that width and lay it across the shelf or anchoring point. The vinyl is also cut to that size and then the treated side of vinyl (with hem or binding) or the hemmed and welded side is merely pressed onto the tape and vinyl curtain looped outward over hangers. When using the removable method, the procedure is the same only that the sticky loop/hook tape is laid on the shelf or anchoring point and the other half of the hook/loop is affixed to the vinyl panel and the two are then pressed together thus anchoring the panel to the shelf. The embodiment when installed in a closet creates a “cape”which is designed to protect the shoulder and collar area of garments that protrude outward from the closet hanger rod.

Typically the present invention would be placed on the outermost portion of the top of the shelf. Typically the binding or hem would not be seen from below.

The present invention, once installed, simply needs to drop down and over the front of the hangered clothes below. The invention covers the rod, the tops of the hangers and the horizontal surfaces of the clothes that protrude forward of the hanger rod.

An objective and advantage of the present invention is that it can protect large linear spans of a closet with a single embodiment. It can be extended to any width giving a continuous, uninterrupted, seamless and clean appearance while other methods of dust protection are limited in size and capacities.

Another objective and advantage of the present invention is that it requires little skill to install.

Another objective and advantage is that the present invention can be customized for various size and shapes of closets.

Another advantage and objective of this invention is that it does not relay on hangers nor hanger rods for support or installation.

Another objective and advantage of this invention is the ease in which it can be cleaned.

Another objective and advantage of this invention is not only that it protects the clothes beneath from dust but given the fact that hangers rest below the embodiment the hangers themselves do not get dusty.

Another advantage and objective is that the clothes can be easily seen and easily removed and replaced with no hanger obstruction with cover.

Another objective and advantage is that in a typical installation the embodiment uses the shelf found above the rod to help in limiting dust accumulation. By so doing, the embodiment only needs to be of such a size as to only cover front half of hanger while other protectors engulf the back side of the garments as well which requires more material and more consumption of the closet's volume space. Is also makes handling clothes more difficult.

Another advantage and objective of this embodiment is the lack of horizontal and vertical lines often present in other protectors given the use of seams, hems, bindings etc. This makes for a cleaner, simpler closet appearance.

Another advantage and objective is the continuous nature of the embodiment with no side walls allows for the sliding of clothes along the rod without impedance.

An objective and advantage of the present invention is that does not relay on hangers nor hanger rods for installation. This allows for clothes on hangers to be freely removed and replaced from the closet rod without impedance and usually requires only one hand.

An objective and advantage of this present invention is that it protects the horizontal surfaces of clothes in a closet from dust.

An objective and advantage of this invention is the ease by which the invention can be removed and replaced when there is a need to gain full access for quick removal of clothes.

An objective and advantage of this invention is its appearance. It is not obtrusive and blends visually into a closet to give a clean, organized appearance and virtually disappears.

An objective and advantage of this invention is its flexibility. It can easily be removed and then it is a simple quick thing to simply put it back. For some reason a person wishes not to have the embodiment in the closet, simply pull it apart and store until it is needed or wanted back in it original place. To replace simply press the two parts back together and the clothes are once again protected from dust.

The present invention once installed is ready to go to work. The vinyl panel should drop out and over the clothes hanging on the below hanger. The invention covers the rod, the tops of the hanger and over the horizontal surfaces of the clothes below. Anything hanging below the present invention is exposed vertically and thus not greatly exposed to falling dust. The lower edge of the invention, or that edge that would hang away from the shelf and extend outward over the hanger and garment is a raw edge having no hem or binding. The left to right edging that determines the width of the embodiment would also be raw. This raw edge would allow exposed edges of the embodiment to camouflage itself with the clothes as there would be no apparent horizontal line or vertical lines giving the closet a clean uncluttered appearance. The upper edge of the vinyl ie. that edge that will be affixed to the top, front or bottom of the rod shelf has adhered/sewn binding, webbing or other material that readily adheres to sticky double sided tape should one desire a semi-permanent application and when the removable application is desired, the sewn webbing or binding gives strength for the stitching holding the hook and loop tape.

The installing of this invention requires a tape measure, scissors and marking device. When using the more permanent method of Installing ie. a two-sided tape, one simply measures the width of the shelf, cuts the two sided tape and lay across the shelf. Now the plastic is measured and cut and the upper edge with its binding of the vinyl is simply pressed onto the two sided tape. When a hook and loop system is used, the procedure is the same only that the sticky loop or hook tape is laid on the shelf and then the plastic curtain with the affixed hook or loop is press onto the exposed hook or loop. The embodiment is laid out over the shelf, out over the hanger rod and over the hangers with garments.

### DESCRIPTION OF PREFERRED EMBODIMENTS

The present invention provides a dust prevention embodiment for clothes being hangered and stored in a closet. It is a system that can be tailored and configured to fit most clothes closets and is a system designed to be easily and quickly installed and if preferred it is readily and easily removable for cleaning or for ease of bulk clothes removal or rearrangement. FIG. 1-7 illustrate the basic components of the system and further illustrate the installation of the system.

FIG. 1 shows the system's components installed in the preferred and typical manner. FIG. 1 shows the existing hanger rod shelf 2 that is typically mounted in a closet space above the hanger rod 6 itself. In FIG. 1 the vinyl panel 1 is mounted to the hanger rod shelf 2 in the normally preferred manner as illustrated in FIG. 2. In this preferred and typical installation shown in FIG. 2 the vinyl panel 1 is using the hook and loop system with 8 being the loop portion of the hook and loop system while 12 is the hook portion the system, typically the loop 8 would be 1½ inches wide. It would be folded over into halves creating a two sided loop hem 9 and the vinyl panel 1 would then be inserted into the fold where it would be permanently affixed by weld or stitch. Positioning of the hook tape 12 is interchangeable with the loop 8 if so desired. FIG. 1 shows the vinyl panel 1 installed in a closet and is looped outward over hanger 3 and extending vertically for short distance. In FIG. 2 the vinyl panel 1 is attached at the preferred and typical location on the hanger rod shelf 2 being the front edge 5 of the top surface of the closet rod shelf 2. FIG. 2 details the attachment of the vinyl panel 1 to the upper surface of the hanger rod shelf 2. The vinyl panel 1 has a loop hem 9 that appears on both sides of vinyl panel 1 while desired anchoring surface 16 has adhesive backed hook 12 adhered to it and the hook and loop is simply pressed together to complete installation of present invention. FIG. 3 shows other possible mounting surfaces for the present invention might include but not limited to the closet wall 10 or the closet ceiling 11. The width of the closet and/or the hanger rod shelf 2 will dictate the width of the vinyl panel 1. Vinyl panel 1 width may be shortened if needed and a plurality 17 of vinyl panels 1 may be added as shown in FIG. 7 as closet and closet hanger rod widths dictate. Once installed, the vinyl panel(s) 1 is pulled forward and over closet hangers and garments on the hangers as shown in FIG. 1. The height of vinyl panel(s) 1 may vary but typically would range from 16 to 20 inches with the minimum being that height required to extend outward from its mounting point and over the horizontal surfaces of any garment hanging on a hanger 3 as shown in FIG. 1. The vinyl panel 1 would then drop vertically for several inches. FIG. 1 shows the joining of the hook and loop surfaces in the completed installation. FIG. 3 shows the present invention ready for final assembly/installation. The adhesive backed hook 12 is attached to front edge 5 of closet rod shelf 2 and the loop 8 of the hook and loop system has been hemmed 9 to both sides of vinyl panel as shown in FIG. 2. FIG. 3 shows the preferred installation surfaces being the front top surface 5 of the closet rod shelf 2, the front bottom surface 14 of the hanger rod shelf 2 and the front edge 15 of the hanger rod shelf 2. In some situations there may be no shelf, in which case the other closet surfaces such as the back wall 10 and closet ceiling 11 may offer mounting alternatives. FIG. 4 an alternative method of attaching loop to the vinyl. Webbing 4 is sewn onto the vinyl to create a hem and one half of a hook and loop system, the loop 8 is affixed preferably by stitch onto the webbing 4. The remaining half of the hook and loop, the hook 12 has adhesive backing and is pressed onto the desired mounting surface 16 and once in place the hook and loop are pressed together to anchor the vinyl panel 1 into place in the closet. FIG. 5 shows the vinyl panel has been folded, welded or stitched together to form a vinyl hem 7. A sticky adhesive tape 18 is affixed to the vinyl hem 7 typically by stitch leaving the sticky side of the tape away from the vinyl hem 7. The sticky tape 18 is then pressed directly onto desired anchoring surface 16 for a semi-permanent installation. FIG. 6 show the vinyl panel 1 with a welded vinyl hem 7 where one part of the two part hook and loop system 8 is sewn directly onto the vinyl hem 7. The remaining part of the hook and loop 12 is affixed by adhesive to the mounting surface 16 which typically would be the front edge 5 of the top side of the hanger rod shelf 2. FIG. 7 further shows the ability of the present invention to be widened with the addition of vinyl panels 17 as may be dictated by the size of a closet. FIG. 7 shows the preferred loop hem 9 along the top edge 13 of present invention while also showing that all the side edges 16 along with bottom edge 18 remaining raw or naked with no hemming etc. This is to allow for an uninterrupted visual appearance.

### BRIEF DESCRIPTION OF THE DRAWINGS

FIG. 1 is an isometric view of the first embodiment of present invention showing features of present invention.

FIG. 2 is a side view of the first embodiment of the present invention shown in FIG. 1 using a hook and loop attachment system on desired attachment surface

FIG. 3 is a isometric of the first embodiment of the present invention in FIG. 1 showing various attachment points in a closet and present invention ready for final installation

FIG. 4 is a side view of the second embodiment of the present invention using a webb/binding hem onto which the loop half of a hook and loop system is affixed and the adhesive backed hook of system is adhered to mounting surface

FIG. 5 is side view of embodiment shown in FIG. 1 of the present invention using the where sticky tape is sewn onto vinyl hem and vinyl panel can be adhered to mounting surface directly with sticky tape

FIG. 6 is a side view embodiment of present invention shown in FIG. 1 showing a vinyl weld creating a hem on which one part of the two part hook and loop system can be sewn with the remaining part of system having an adhesive back which is adhered to mounting surface

FIG. 7 is front view of present invention showing the joining together of several panels and shows hem m on top edge of vinyl panels with remaining edges being raw

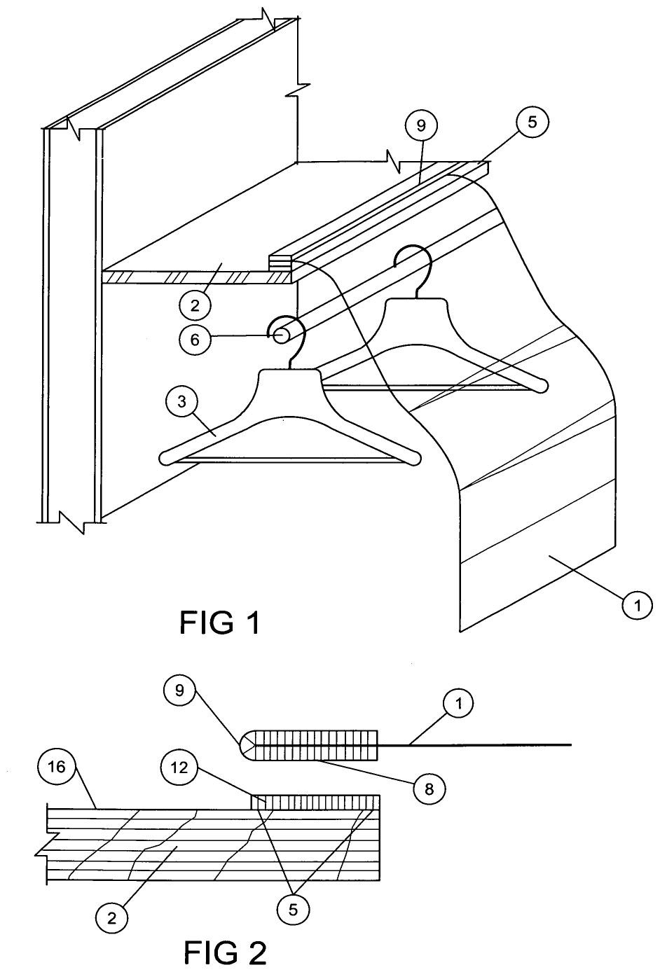

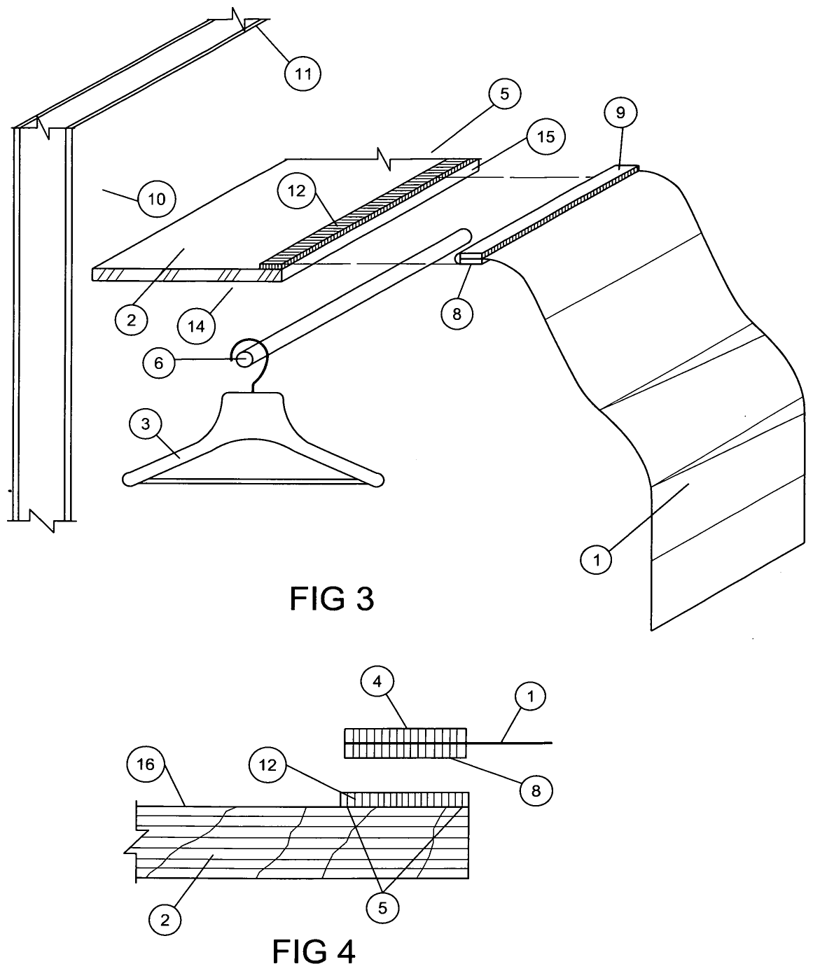

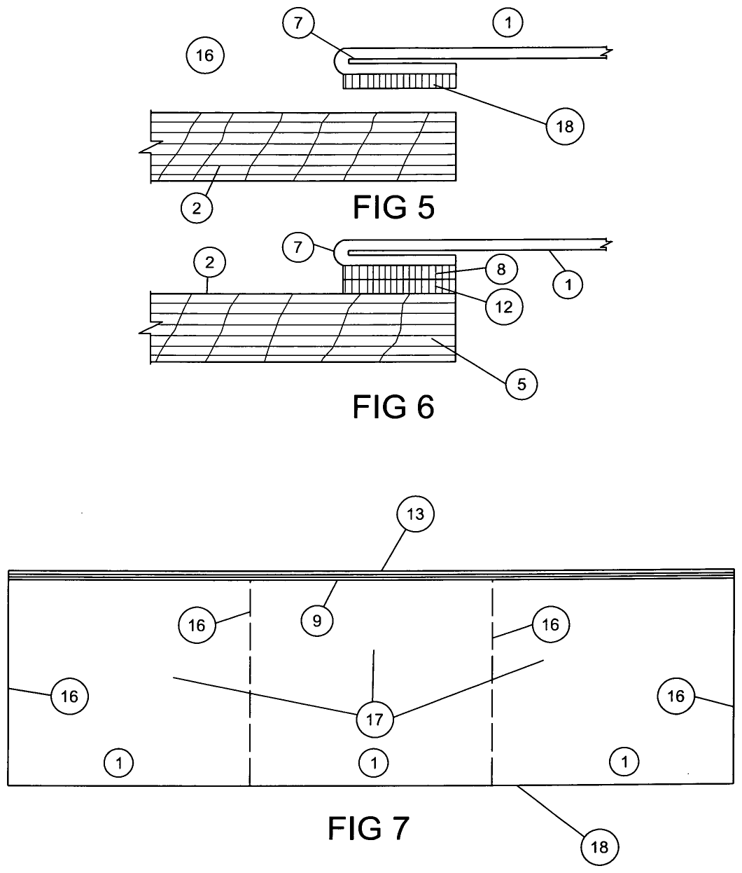

Having thus described my invention and the manner in which it may be used, I claim:

1. An embodiment that protects clothes hanging in a closet from the accumulation of dust comprising :
a. a flat, single plane, elongated, rectangular panel of vinyl in which the two side edges and one of the elongated edges remain raw and absent of any embodiments.
b. a flat, single plane elongated panel of vinyl in which one of the elongated edges is wrapped or folded over then stitched or welded to form a hem on that elongated edge that is the upper horizontal edge of vinyl panel when panel is installed.
c. a “hook and loop” system in which one part of the two part hook and loop system is affixed, by stitch or weld, to the upper elongated edge of the vinyl panel in a continuous fashion and the remaining part of the two part hook and loop system is adhesive backed, and is attached to desired anchoring surface with in the closet preferably a surface on the hanger rod shelf.

2. The dust accumulation protection system of claim 1 that does not use nor rely on the hanger rod nor a hanger hanging on the hanger rod for closet installation.
a. present invention does not require the hanger rod nor hanger for primary support.
b. present invention uses hanger rod shelf and other surfaces for primary support
c. present invention does not touch hanger rod nor impedes with hanger rod thus allowing freedom of hanger movement or removal.
d. present invention may be removed from closet without removal of clothes within that closet.

3. A dust accumulation protection system that can be customized and tailored to a closet.
a. The dust protection system is comprised of individual vinyl panels that can be cut or shortened to match the width of desired application or can be added to with additional panels for a limitless distance yet providing a continuous, uninterrupted protective sheath.
b. The embodiment can easily be installed to accommodate a radius or a right angle in a continuous and uninterrupted fashion.

4. A dust accumulation system that does not fully nor partially encapulate garments hanging in a closet.
a. The embodiment of claim 1 covers only that horizontal portion of garments hanging forward of the closet hanger rod and upon reaching the outmost horizontal point of hanging garment descends vertically down garment for several inches while relying on the hanger rod shelf to protect remaining horizontal surfaces of hanging garments. from dust accumulation.
b. An embodiment of claim 1 that does not require the removal of the dust protector for the removal of a garment or a hanger being protected by a dust protector.

5. An embodiment of claim 1 that uses the closet shelf, closet back wall or closet ceiling for attachment points and installation.

6. An embodiment of claim 1 that uses “hook and loop” to create a removable system.

7. An embodiment of claim 1 that is semi-permanent in nature.
a. webbing or binding is affixed to one upper long edge of vinyl panel
b. two sided tape is placed continuously along anchoring point and vinyl panel is then pressed onto installed sticky two sided tape
